(19) United States
(12) Patent Application Publication
(10) Pub. No.: US 2014/0089311 A1
(43) Pub. Date: Mar. 27, 2014

(54) SYSTEM. METHOD, AND COMPUTER-READABLE MEDIUM FOR CLASSIFYING PROBLEM QUERIES TO REDUCE EXCEPTION PROCESSING

(71) Applicants: Anita Richards, San Juan Capistrano, CA (US); Douglas Brown, Rancho Santa Fe, CA (US); Bruce Britton, Valencia, CA (US); Todd Walter, San Diego, CA (US)

(72) Inventors: Anita Richards, San Juan Capistrano, CA (US); Douglas Brown, Rancho Santa Fe, CA (US); Bruce Britton, Valencia, CA (US); Todd Walter, San Diego, CA (US)

(21) Appl. No.: 13/627,203

(22) Filed: Sep. 26, 2012

(51) Int. Cl. G06F 17/30

(52) U.S. Cl. 707/737; 707/E17.046

(57) ABSTRACT

A system, method, and computer-readable medium that facilitate classification of database requests as problematic based on estimated processing characteristics of the request are provided. Estimated processing characteristics may include estimated skew including central processing unit skew and input/output operation skew, central processing unit duration per input/output operation, and estimated memory usage. The estimated processing characteristics are made on a request step basis. The request is classified as problematic responsive to determining one or more of the estimated characteristics of a request step exceed a corresponding threshold. In this manner, mechanisms for predicting bad query behavior are provided. Workload management of those requests may then be more successfully provided through workload throttles, filters, or even a more confident exception detection that correlates with the estimated bad behavior.

### CROSS-REFERENCES TO THE RELATED APPLICATIONS

THIS application IS A CONTINUATION IN PART (CIP) OF, AND TAKE PRIORITY FROM, THE U.S. PATENT APPLICATION NO., 11/435,523, FILED ON MAY 17, 2006, ENTITLED: “MANAGING DATABASE UTILITIES TO IMPROVE THROUGHPUT AND CONCURRENCY,” WHICH IS HEREBY INCORPORATED BY REFERENCE HEREIN IN ITS ENTIRETY AND FOR ALL PURPOSES.

THIS application IS ALSO A CONTINUATION OF, AND TAKE PRIORITY FROM, THE U.S. PATENT APPLICATION NO. 12/339,574, FILED ON DECEMBER 19, 2008, ENTITLED: “SYSTEM, METHOD, AND COMPUTER-READABLE MEDIUM FOR CLASSIFYING PROBLEM QUERIES TO REDUCE EXCEPTION PROCESSING,” WHICH IS HEREBY INCORPORATED BY REFERENCE HEREIN IN ITS ENTIRETY AND FOR ALL PURPOSES.

### BACKGROUND

A database is a collection of stored data that is logically related and that is accessible by one or more users or applications. A popular type of database is the relational database management system (RDBMS), which includes relational tables, also referred to as relations, made up of rows and columns (also referred to as tuples and attributes). Each row represents an occurrence of an entity defined by a table, with an entity being a person, place, thing, or other object about which the table contains information.

One of the goals of a database management system is to optimize the performance of queries for access and manipulation of data stored in the database. Given a target environment, an optimal query plan is selected, with the optimal query plan being the one with the lowest cost, e.g., response time, CPU processing, I/O processing, network processing, as determined by an optimizer. The response time is the amount of time it takes to complete the execution of a query on a given system. In this context, a “workload” is a set of requests, which may include queries or utilities, such as loads, that have some common characteristics, such as application, source of request, type of query, priority, response time goals, etc.

Certain problematic query requests cannot be detected prior to query execution. For example, a query applied to skewed data, a query with high central processing unit (CPU)-to-input/output (I/O) processing ratios, or a query that consumes excess amounts of data often may not be detected prior to execution of the query. In some cases, these situations may be detected during execution and can be acted upon with exception processing, for example by changing the workload to be one with a much lower priority, or by aborting the query. However exception processing comes with some trade-offs and inefficiencies. In some situations, high priority resources are allocated for a time to requests that shouldn't be allocated the high priority resource thereby disadvantageously impacting true high priority request response times, and workload throttle effectiveness is compromised. Because changing (or reclassifying) a query request to operate in a new workload (WD) bypasses the same workload throttle, requests that are “reclassified” due to an exception are not subject to the throttle queue and thus are provided an unfair processing advantage. This also increases workload concurrency levels beyond that intended for the workload. In turn, unacceptably long periods where low priority requests are allocated critical resources required by higher priority requests may result, especially when the change-to workload has a very low priority weight or an absolute CPU limit.

The exception action option to abort is often not well received. In many scenarios, rejecting or aborting a request is not a viable option. Likewise, “tuning” problematic queries generated by partner tools or various application development teams is often impractical from the database administrator's (DBA's) perspective. Further, in the case of an exception to detect skew, a request displaying skewed behavior is not necessarily the request that caused the skew. Consequently, automated exception actions are often problematic because a targeted request may not be causing the skewed behavior.

### SUMMARY

Disclosed embodiments provide a system, method, and computer readable medium for classifying database requests as problematic based on estimated processing characteristics of the request. Estimated processing characteristics may include estimated skew including central processing unit skew and input/output operation skew, central processing unit duration per input/output operation, and estimated memory usage. The estimated processing characteristics are made on a request step basis. The request is classified as problematic responsive to determining one or more of the estimated characteristics of a request step exceed a corresponding threshold. In this manner, mechanisms for predicting bad query behavior are provided. Workload management of those requests may then be more successfully provided through workload throttles, filters, or even a more confident exception detection that correlates with the estimated bad behavior.

### BRIEF DESCRIPTION OF THE DRAWINGS

Aspects of the present disclosure are best understood from the following detailed description when read with the accompanying figures, in which:

FIG. 1 depicts a diagrammatic representation of an exemplary architecture for a large database system that is suited for implementing mechanisms for classifying problem queries to reduce exception processing in accordance with disclosed embodiments;

FIG. 2 depicts a diagrammatic representation of a sample architecture for one node of the database system depicted in FIG. 1;

FIG. 3 is a diagrammatic representation of a parsing engine implemented in accordance with an embodiment;

FIG. 4 is a diagrammatic representation of a parser implemented in accordance with an embodiment;

FIG. 5 is a diagrammatic representation of an exemplary system management implemented in accordance with disclosed embodiments;

FIG. 6 is a diagrammatic representation of a query flow processing routine; and

FIG. 7 is a flowchart of a problem query classification routine implemented in accordance with disclosed embodiments

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

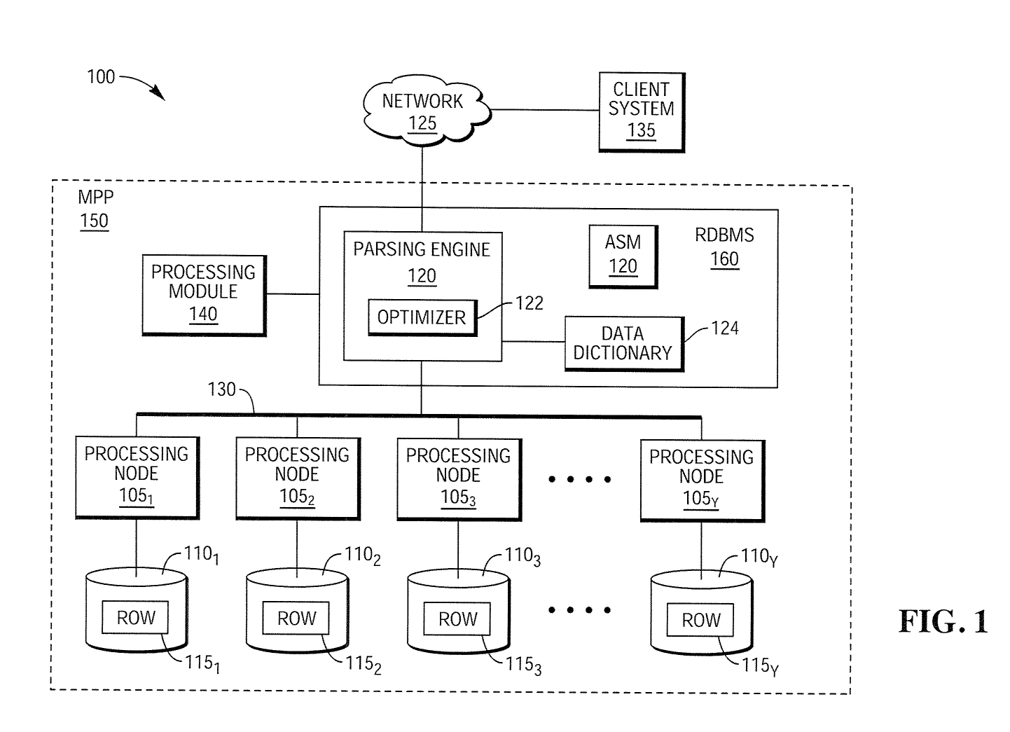

FIG. 1 depicts a diagrammatic representation of an exemplary architecture for a large database system 100, such as a Teradata Active Data Warehousing System, that is suited for implementing mechanisms for classifying problem queries to reduce exception processing in accordance with disclosed embodiments. The database system 100 includes a relational database management system (RDBMS) 160 built upon a massively parallel processing (MPP) system 150.

As shown, the database system 100 includes one or more processing nodes 105_{1 . . . Y} that manage the storage and retrieval of data in data-storage facilities 110₁ . . . _{Y}. Each of the processing nodes may host one or more physical or virtual processing modules, such as one or more access module processors (AMPs). Each of the processing nodes 105₁ . . . _{Y} manages a portion of a database that is stored in a corresponding one of the data-storage facilities 110₁ . . . _{Y}. Each of the data-storage facilities 110₁ . . . _{Y} includes one or more disk drives or other storage medium.

The system stores data in one or more tables in the data-storage facilities 110₁ . . . _{Y}. The rows 115₁ . . . _{Y} of the tables are stored across multiple data-storage facilities 110₁ . . . _{Y} to ensure that the system workload is distributed evenly across the processing nodes 105₁ . . . _{Y}. A parsing engine 120 organizes the storage of data and the distribution of table rows 115₁ . . . _{Y} among the processing nodes 105₁ . . . _{Y} and accesses processing nodes 105₁ . . . _{Y} via an interconnect 130. The parsing engine 120 also coordinates the retrieval of data from the data-storage facilities 110₁ . . . _{Y} in response to queries received from a user, such as one at a client computer system 135 connected to the database system 100 through a network 125 connection. The parsing engine 120, on receiving an incoming database query, applies an optimizer 122 component to the query to assess the best plan for execution of the query. Selecting the optimal query-execution plan includes, among other things, identifying which of the processing nodes 105₁ . . . _{Y} are involved in executing the query and which database tables are involved in the query, as well as choosing which data-manipulation techniques will serve best in satisfying the conditions of the query. To this end, the parser and/or optimizer may access a data dictionary 124 that specifies the organization, contents, and conventions of one or more databases. For example, the data dictionary 124 may specify the names and descriptions of various tables maintained by the MPP system 150 as well as fields of each database. Further, the data dictionary 124 may specify the type, length, and/or other various characteristics of the stored tables. The database system typically receives queries in a standard format, such as the Structured Query Language (SQL) put forth by the American National Standards Institute (ANSI).

The system 100 may include an active system management (ASM) 126 module. The ASM may be implemented as a “closed-loop” system management (CLSM) architecture capable of satisfying a set of workload-specific goals. In other words, the system is a goal-oriented workload management system capable of supporting complex workloads and capable of self-adjusting to various types of workloads.

The ASM 126 operation has four major phases: 1) assigning a set of incoming request characteristics to workload groups, assigning the workload groups to priority classes, and assigning goals (called Service Level Goals or SLGs) to the workload groups; 2) monitoring the execution of the workload groups against their goals; 3) regulating (adjusting and managing) the workload flow and priorities to achieve the SLGs; and 4) correlating the results of the workload and taking action to improve performance. The performance improvement can be accomplished in several ways: 1) through performance tuning recommendations such as the creation or change in index definitions or other supplements to table data, or to recollect statistics, or other performance tuning actions, 2) through capacity planning recommendations, for example increasing system power, 3) through utilization of results to enable optimizer self-learning, and 4) through recommending adjustments to SLGs of one workload to better complement the SLGs of another workload that it might be impacting. All recommendations can either be enacted automatically, or after “consultation” with the database administrator (DBA).

The DBS 100 described herein accepts performance goals for each workload as inputs, and dynamically adjusts its own performance, such as by allocating DBS 100 resources and throttling back incoming work. In one example system, the performance parameters are referred to as priority scheduler parameters. When the priority scheduler is adjusted, weights assigned to resource partitions and allocation groups are changed. Adjusting how these weights are assigned modifies the way access to system resources, e.g., the CPU, disk and memory, is allocated among requests. Given performance objectives for each workload and the fact that the workloads may interfere with each other's performance through competition for shared resources, the DBS 100 may find a performance setting that achieves one workload's goal but makes it difficult to achieve another workload's goal.

The performance goals for each workload will vary widely as well, and may or may not be related to their resource demands. For example, two workloads that execute the same application and DBS 100 code could have differing performance goals simply because they were submitted from different departments in an organization. Conversely, even though two workloads have similar performance objectives, they may have very different resource demands.

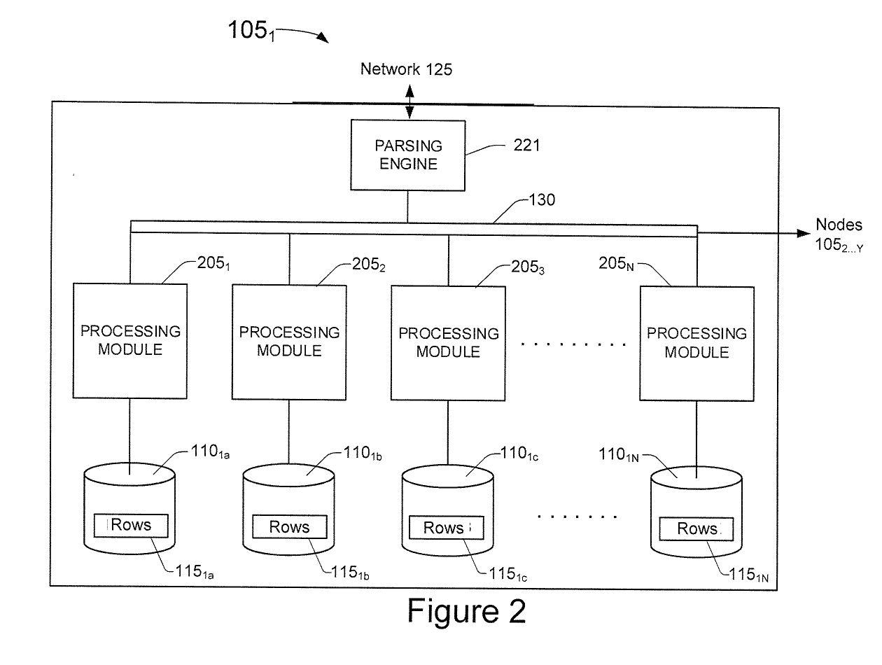

FIG. 2 depicts a diagrammatic representation of a sample architecture for one node 105₁ of the DBS 100. The DBS node 105₁ includes one or more processing modules 205_{1 . . . N} connected by an interconnect 130 that manage the storage and retrieval of data in data-storage facilities 110_{1a . . . 1N}. Each of the processing modules 205_{1 . . . N} may be one or more physical processors or each may be a virtual processor, with one or more virtual processors running on one or more physical processors. For the case in which one or more virtual processors are running on a single physical processor, the single physical processor swaps between the set of N virtual processors. For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 205_{1 . . . N} manages a portion of a database that is stored in a corresponding one of the data-storage facilities 110_{1a . . . 1N}. Each of the data-storage facilities 110_{1a . . . 1N} includes one or more disk drives. The DBS may include multiple nodes 105_{2 . . . Y} in addition to the illustrated node 105₁, connected by way of the interconnect 130.

The system stores data in one or more tables in the data-storage facilities 110_{1a . . . 1N}. The rows 115_{1a . . . 1N} of the tables are stored across multiple data-storage facilities 110_{1a . . . 1N} to ensure that the system workload is distributed evenly across the processing modules 205_{1 . . . N}. A parsing engine 221 organizes the storage of data and the distribution of table rows 110_{1a . . . 1N} among the processing modules 205_{1 . . . 1N}. The parsing engine 221 also coordinates the retrieval of data from the data-storage facilities 110_{1a . . . 1N} in response to queries received from a user at a client computer system 135_{1 . . . N}. The DBS 100 usually receives queries and commands to build tables in a standard format, such as SQL.

In one implementation, the rows 115_{1a . . . 1N} are distributed across the data-storage facilities 110_{1a . . . 1N} by the parsing engine 221 in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to data-storage facilities 110_{1a . . . 1N} and associated processing modules 205_{1 . . . N} by a hash bucket map. The characteristics of the columns chosen for the primary index determine how evenly the rows are distributed.

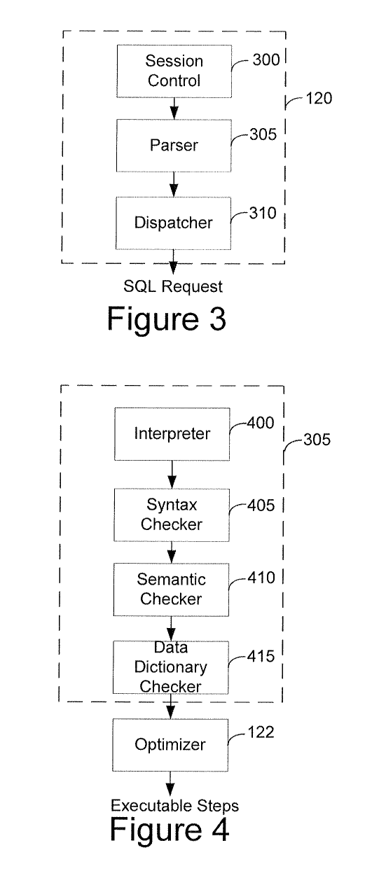

In one example system, a parsing engine, such as the parsing engine 120, is made up of three components: a session control 300, a parser 305, and a dispatcher 310 as shown in FIG. 3. The session control 300 provides the logon and logoff functions. It accepts a request for authorization to access the database, verifies it, and then either allows or disallows the access. Once the session control 300 allows a session to begin, a user may submit a SQL request that is routed to the parser 305. As illustrated in FIG. 4, the parser 305 interprets the SQL request (block 400), checks the request for correct SQL syntax (block 405), evaluates the request semantically (block 410), and consults a data dictionary to ensure that all of the objects specified in the SQL request exist and that the user has the authority to perform the request (block 415). Finally, the parser 305 runs the optimizer 122 that selects the least expensive plan to perform the request.

The database management system described herein accepts performance goals for each workload as inputs, and may dynamically adjust system resources, such as by allocating DBMS resources and throttling back incoming work, using the goals as a guide. The performance goals for each workload may vary widely, and may or may not be related to their resource demands. For example, two workloads that execute the same application and DBMS code may have differing performance goals simply because they were submitted from different departments in an organization. Conversely, even though two workloads have similar performance objectives, they may have very different resource demands. In an embodiment, the system may include a “closed-loop” workload management architecture capable of satisfying a set of workload-specific goals. In other words, the system is an automated goal-oriented workload management system capable of supporting complex workloads and capable of self-adjusting to various types of workloads. The system's operation has four major phases: 1) assigning a set of incoming request characteristics to workload groups, assigning the workload groups to priority classes, and assigning goals (called Service Level Goals or SLGs) to the workload groups; 2) monitoring the execution of the workload groups against their goals; 3) regulating (adjusting and managing) the workload flow and priorities to achieve the SLGs; and 4) correlating the results of the workload and taking action to improve performance. The performance improvement can be accomplished in several ways: 1) through performance tuning recommendations such as the creation or change in index definitions or other supplements to table data, or to recollect statistics, or other performance tuning actions, 2) through capacity planning recommendations, for example increasing system power, 3) through utilization of results to enable optimizer self-learning, and 4) through recommending adjustments to SLGs of one workload to better complement the SLGs of another workload that it might be impacting. All recommendations can either be enacted automatically, or after “consultation” with the database administrator (“DBA”).

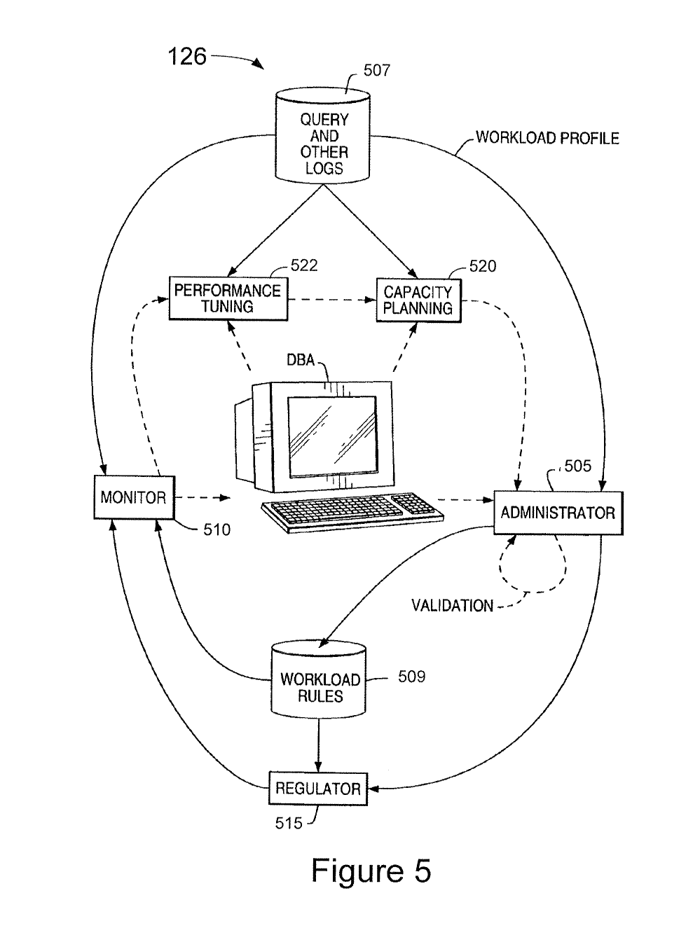

FIG. 5 is a diagrammatic representation of an exemplary system management 126 implemented in accordance with disclosed embodiments. The system includes an Administrator 505 that provides a Graphical User Interface (“GUI”) to define workloads and their SLGs and other workload management requirements. The administrator 505 accesses data in logs 507 associated with the system, including a query log, and receives capacity planning 520 and performance tuning 522 inputs. The administrator 505 is a primary interface for a DBA. The administrator also establishes workload rules 509, which are accessed and used by other elements of the system.

A Monitor 510 provides a top level dashboard view, and the ability to drill down to various details of workload group performance, such as aggregate execution time, execution time by request, aggregate resource consumption, resource consumption by request, etc. Such data is stored in the query log and other logs 507 available to the monitor 510. The monitor 510 also includes processes that provide long term trend reporting, which may include providing performance improvement recommendations.

Some of the monitor functionality may be performed by a regulator 515 that dynamically adjusts system settings and/or projects performance issues and either alerts the database administrator (DBA) or another user to take action, for example, by communication through the monitor 510, which is capable of providing alerts, or through the exception log, providing a way for applications and their users to become aware of, and take action on, regulator actions. Alternatively, the regulator 515 may automatically take action by deferring requests or executing requests with the appropriate priority to yield the best solution given requirements defined by the administrator 505.

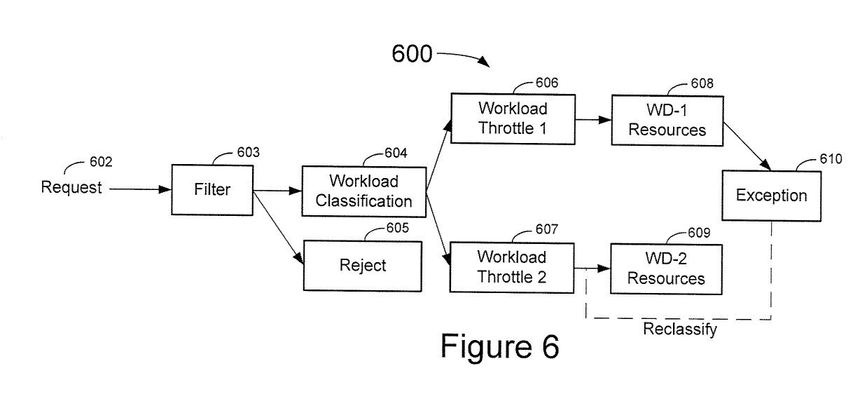

FIG. 6 is a diagrammatic representation of a query flow processing routine. A request 602 is submitted for processing and is applied to a filter 603. Filter 603 may specify filtering rules that are applied when a request is submitted to the database system before the request is executed. The filter either accepts the request for processing and submits the request to a workload classification (block 604) or rejects (block 605) the request. In one example system, the filtering rules may accept or reject the request based on, for example, (a) who submitted the request, (b) what table is to be accessed by the request, (c) estimated processing of the request, etc. Further, these rules may include an ability to filter on the type of statement, such as SELECT, INSERT, DELETE, etc. These rules are applied before a request is classified into a workload. Assume the request is passed by the filter and is received for an evaluation for classification of the request by a workload classification module (block 604). A workload classification is assigned to the workload. In the illustrative example, two workload classifications (illustratively designated WD-1 and WD-2) may be assigned to a received request. A throttle, such as a throttle 606 associated with requests classified as WD-1 or a throttle 607 associated with requests classified as WD-2, may then be applied to processing of the workload. In the illustrative example, assume the received request 602 is classified as WD-1. Accordingly, resources 608 allocated for WD-1 may then be applied to processing of the request. In contemporary systems, an exception 610 may be thrown during processing of the request, and the request may then be reclassified to another workload. In the present example, the request is reclassified to WD-2, and the resources 609 allocated for requests of WD-2 are then applied to processing of the request. Disadvantageously, the workload throttle 607 may be bypassed, and the request may then be allocated a disproportionate share of the system resources.

The disclosed mechanisms deal more graciously with “bad” or problematic queries by providing additional workload classification types that minimize the need to use exceptions, thereby avoiding the trade-offs discussed above. As referred to herein, a workload is a set of requests, which may include queries or utilities, such as loads, that have some common characteristics, such as application, source of request, type of query, priority, response time goals, etc., and a “multi-class workload” is an environment with more than one workload. Automatically managing and adjusting database management system (DBMS) resources (tasks, queues, Central Processing Unit (“CPU”), memory, memory cache, disk, network, etc.) in order to achieve a set of per-workload response time goals for a complex multi-class workload is challenging because of the inter-dependence between workloads that results from their competition for shared resource.

It is highly desirable to detect and act on these problematic query behaviors. As a best practice, classifications are promoted over exceptions as much as possible. To this end, mechanisms are provided to classify a request that is estimated to demonstrate problematic behavior. Classifications for potentially problematic requests include, but are not limited to, classification of queries on estimated skew characteristics, estimated CPU duration per I/O ratio characteristics, and estimated memory consumption characteristics.

To facilitate workload management provisioning of potentially problematic query classifications, a “white tree” or other data structure that specifies a representation of an optimizer-derived join plan for a query is enhanced to provide step-level skew estimates so that skew is not washed out through full query aggregations across all steps. In an embodiment, the estimates contain both an estimated skew percentage along with regular estimated processing time associated with the particular query processing step so that the skew can be ‘qualified’ to be of sufficient size to classify the request as problematic. In other words, the metrics are captured on a query step basis and correlated with each other. For example, consider a query step 1 that has an estimated skew of 40% and an estimated processing time of one second and a query step 2 has an estimated skew of 30% with an estimated processing time of that step being 3600 seconds. In such a scenario, it is clear that step 2's skew, even though it is smaller, is more serious than step 1's skew.

In accordance with an embodiment, two skew estimates are provided for each query step—one based on CPU and the other based on input/output (I/O) operations. As referred to herein, skew may be defined according to the following:

Skew=((HighAMP−AvgAMP)/HighAMP)*100

where the HighAMP value is a load metric of a particular AMP and AvgAMP is a metric of the average load of the AMPs in the system.

In accordance with an embodiment, the optimizer generates step-level CPU interval per I/O ratio estimates so that the metrics are not washed out through full query aggregations across all steps. The estimates contain both the estimated CPU duration per I/O ratio along with regular estimated processing time associated with the step so that the estimated CPU duration per I/O ratio can be ‘qualified’ to be of sufficient size.

Certain requests may consume disproportionately high amounts of memory and impact the performance of the system when memory failures, paging, and swapping activities occur. To facilitate workload management provisioning of a problematic query classification, the optimizer provides step-level memory usage estimates so that the metrics are not washed out through full query aggregations across all steps, or memory usage estimates are not confused by whether the usage is consumed serially or all at once. The DBA may specify a memory usage threshold as a percentage of total configured memory to facilitate classification of a request as problematic.

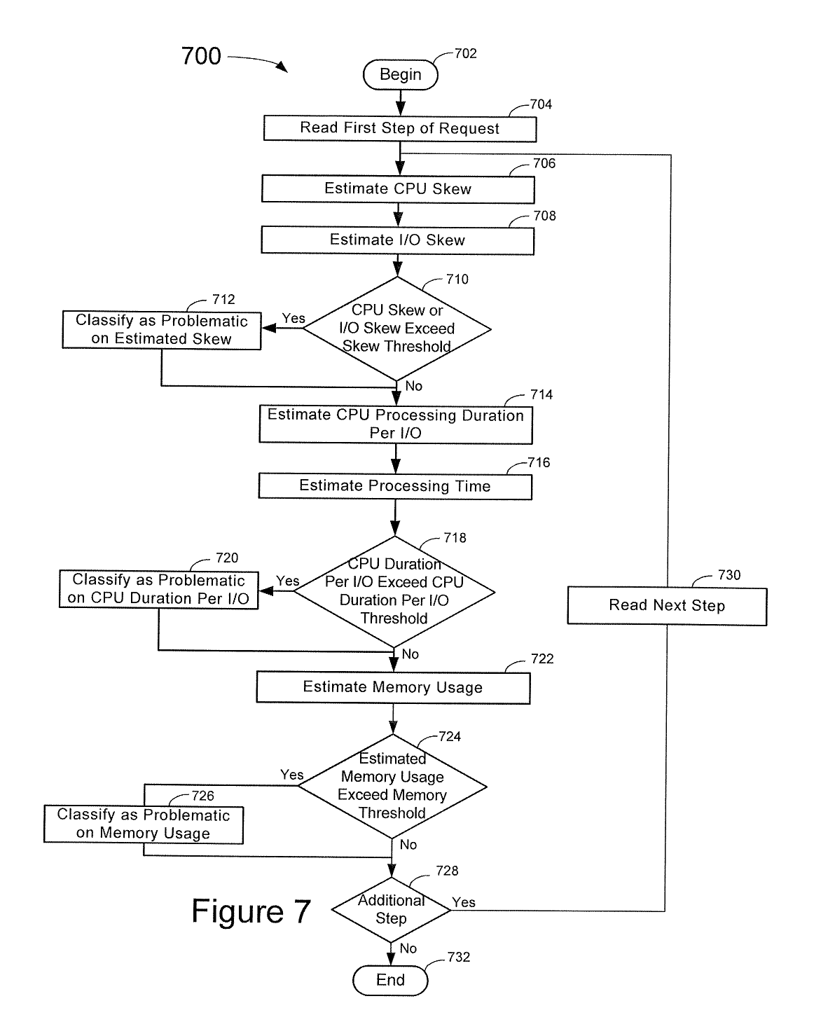

FIG. 7 is a flowchart 700 of a problem query classification routine implemented in accordance with disclosed embodiments. The processing steps of FIG. 7 may be implemented as computer-executable instructions tangibly embodied on a computer-readable medium executable by a processing system, such as the processing module 140 depicted in FIG. 1.

The problem query classification routine is invoked (step 702), and a first step of a request is read (step 704). CPU skew for the first step is estimated (step 706) as well as I/O skew (step 708). An evaluation is then made to determine if the CPU skew or I/O skew exceeds a respective CPU or I/O skew threshold, and is estimated to be sustained as such for a CPU consumption amount that exceeds the qualifying CPU processing threshold (step 710). If so, the request is classified as problematic based on estimated skew (step 712), and the classification routine may then proceed to estimate the CPU processing duration per I/O (step 714). If it is determined at step 710 that neither the CPU skew or I/O skew exceeds a respective CPU or I/O skew threshold, the classification routine may then proceed to estimate the CPU processing duration per I/O according to step 714.

A processing time is then estimated (step 716), and an evaluation is then made to determine if the CPU consumption amount per I/O exceeds a CPU consumption amount per I/O threshold, and is estimated to be sustained as such for a CPU consumption amount that exceeds the qualifying CPU processing threshold (step 718). If so, the query is classified as problematic based on the CPU duration per I/O estimate (step 720). The classification routine may then proceed to estimate the memory usage for the currently evaluated request step (step 722). If it is determined at step 718 that the estimated CPU duration per I/O does not exceed a CPU duration per I/O threshold, the classification routine may then proceed to estimate the memory usage according to step 722.

After estimation of the memory usage for the currently evaluated request step, the classification routine may then evaluate whether the estimated memory usage exceeds a memory usage threshold (step 724). If so, the request may then be classified as problematic based on the estimated memory usage (step 726), and the classification routine may then evaluate whether an additional request step remains for evaluation (step 728). If the estimated memory usage of the currently evaluated request step does not exceed a memory usage threshold, the classification routine may proceed to evaluate whether an additional request step remains for evaluation according to step 728. If another request step remains for evaluation, the classification routine may read the next request step (step 730), and return to step 706 to estimate the CPU skew for the currently evaluated request step. When no additional request steps remain for evaluation, the classification routine cycle may end (step 732).

In this manner, estimated problematic query behavior is provided. Advantageously, workload throttles or filters may be allocated for requests classified as problematic, and exception processing of such queries may be advantageously averted.

As described, mechanisms for classifying database requests as problematic based on estimated processing characteristics of the request are provided. Estimated processing characteristics may include estimated skew including central processing unit skew and input/output operation skew, central processing unit duration per input/output operation, and estimated memory usage. The estimated processing characteristics are made on a request step basis. The request is classified as problematic responsive to determining one or more of the estimated characteristics of a request step exceed a corresponding threshold. In this manner, mechanisms for predicting bad query behavior are provided. Workload management of those requests may then be more successfully provided through workload throttles, filters, or even a more confident exception detection that correlates with the estimated bad behavior.

The flowchart of FIG. 7 depicts process serialization to facilitate an understanding of disclosed embodiments and is not necessarily indicative of the serialization of the operations being performed. In various embodiments, the processing steps described in FIG. 7 may be performed in varying order, and one or more depicted steps may be performed in parallel with other steps. Additionally, execution of some processing steps of FIG. 7 may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the disclosed embodiments may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of the disclosed embodiments can be loaded onto a computer. The computer program is not limited to any particular embodiment, and may, for example, be implemented in an operating system, application program, foreground or background process, or any combination thereof, executing on a single processor or multiple processors. Additionally, various steps of embodiments may provide one or more data structures generated, produced, received, or otherwise implemented on a computer-readable medium, such as a memory.

Although disclosed embodiments have been illustrated in the accompanying drawings and described in the foregoing description, it will be understood that embodiments are not limited to the disclosed examples, but are capable of numerous rearrangements, modifications, and substitutions without departing from the disclosed embodiments as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information. Still further, although depicted in a particular manner, a greater or lesser number of modules and connections can be utilized with the present disclosure in order to accomplish embodiments, to provide additional known features to present embodiments, and/or to make disclosed embodiments more efficient. Also, the information sent between various modules can be sent between the modules via at least one of a data network, an Internet Protocol network, a wireless source, and a wired source and via a plurality of protocols.

1. A method of classifying requests in a database system deployed in a computer system, comprising:
receiving a plurality of steps of a database request;
estimating processing characteristics of one or more of the request steps;
assigning the request a problematic classification responsive to determining at least one of the processing characteristics exceeds a specified threshold; and
processing the request according to the problematic classification.

2. The method of claim 1, wherein estimating processing characteristics comprises determining at least one of an estimated skew, an estimated central processing unit duration per input/output ratio, and an estimated memory consumption for the respective one or more request steps.

3. The method of claim 1, wherein estimating processing characteristics comprises:
determining an estimated central processing unit skew for the respective one or more request steps; and
determining an estimated input/output skew for the respective one or more request steps.

4. The method of claim 3, further comprising:
comparing the estimated central processing unit skew with a central processing unit skew threshold; and
comparing the estimated input/output skew with an input/output skew threshold, wherein assigning a problematic classification comprises assigning a problematic skew classification to the request responsive to determining at least one of the estimated central processing unit skew and the estimated input/output skew exceeds the respective central processing unit skew threshold and the input/output skew threshold.

5. The method of claim 1, wherein estimating processing characteristics comprises:
determining an estimated central processing unit duration per input/output operation for the respective one or more request steps; and
determining an estimate of processing time for the respective one or more request steps.

6. The method of claim 5, further comprising comparing the estimated central processing unit duration per input/output operation with a central processing unit duration per input/output operation threshold, wherein assigning a problematic classification comprises assigning a problematic central processing unit duration per input/output operation classification to the request responsive to determining the estimated central processing unit duration per input/output operation exceeds the central processing unit duration per input/output operation threshold.

7. The method of claim 1, wherein estimating processing characteristics comprises determining an estimated memory usage for the respective one or more request steps.

8. The method of claim 7, further comprising comparing the estimated memory usage with a memory usage threshold, wherein assigning a problematic classification comprises assigning a problematic memory usage classification to the request responsive to determining the estimated memory usage exceeds the memory usage threshold.

9. The method of claim 1, wherein processing the request according to the problematic classification comprises rejecting the request from executing.

10. A computer-readable medium having computer-executable instructions for execution by a processing system, the computer-executable instructions for classifying requests in a database system deployed in a computer system, the computer-executable instructions, when executed, cause the processing system to:
receive a plurality of steps of a database request;
estimate processing characteristics of one or more of the request steps;
assign the request a problematic classification responsive to determining at least one of the processing characteristics exceeds a specified threshold; and
process the request according to the problematic classification.

11. The computer-readable medium of claim 10, wherein the instructions that estimate processing characteristics comprise instructions that determine at least one of an estimated skew, an estimated central processing unit duration per input/output ratio, and an estimated memory consumption for the respective one or more request steps.

12. The computer-readable medium of claim 10, wherein the instructions that estimate processing characteristics comprise instructions that, when executed, cause the processing system to:
determine an estimated central processing unit skew for the respective one or more request steps; and
determine an estimated input/output skew for the respective one or more request steps.

13. The computer-readable medium of claim 12, further comprising instructions that,
when executed, cause the processing system to:
compare the estimated central processing unit skew with a central processing unit skew threshold; and
compare the estimated input/output skew with an input/output skew threshold, wherein assigning a problematic classification comprises assigning a problematic skew classification to the request responsive to determining at least one of the estimated central processing unit skew and the estimated input/output skew exceeds the respective central processing unit skew threshold and the input/output skew threshold.

14. The computer-readable medium of claim 10, wherein the instructions that estimate processing characteristics comprise instructions that, when executed, cause the processing system to:
determine an estimated central processing unit duration per input/output operation for the respective one or more request steps; and
determine an estimate of processing time for the respective one or more request steps.

15. The computer-readable medium of claim 14, further comprising instructions that, when executed, cause the processing system to compare the estimated central processing unit duration per input/output operation with a central processing unit duration per input/output operation threshold, wherein the instructions that assign a problematic classification comprise instructions that, when executed, assign a problematic central processing unit duration per input/output operation classification to the request responsive to determining the estimated central processing unit duration per input/output operation exceeds the central processing unit duration per input/output operation threshold.

16. The computer-readable medium of claim 10, wherein the instructions that estimate processing characteristics comprise instructions that, when executed, cause the processing system to determine an estimated memory usage for the respective one or more request steps.

17. The computer-readable medium of claim 16, further comprising instructions that, when executed, cause the processing system to compare the estimated memory usage with a memory usage threshold, wherein the instructions that assign a problematic classification comprise instructions that, when executed, cause the processing system to assign a problematic memory usage classification to the request responsive to determining the estimated memory usage exceeds the memory usage threshold.

18. The computer-readable medium of claim 10, wherein the instructions that process the request according to the problematic classification comprise instructions that, when executed, cause the processing system to reject the request from executing.

19. A computer system having a database management system deployed therein configured to classify requests, comprising:
at least one storage medium on which the database management system is stored; and
at least one processing module that receives a plurality of steps of a database request, estimates processing characteristics of one or more of the request steps, assigns the request a problematic classification responsive to determining at least one of the processing characteristics exceeds a specified threshold, and processes the request according to the problematic classification.

20. The system of claim 19, wherein the processing module estimates processing characteristics by determining at least one of an estimated skew, an estimated central processing unit duration per input/output ratio, and an estimated memory consumption for the respective one or more request steps.

21. The system of claim 19, wherein the processing module estimates processing characteristics by determining an estimated central processing unit skew for the respective one or more request steps, and determines an estimated input/output skew for the respective one or more request steps, wherein the processing module compares the estimated central processing unit skew with a central processing unit skew threshold, compares the estimated input/output skew with an input/output skew threshold, and assigns the problematic classification as a problematic skew classification responsive to determining at least one of the estimated central processing unit skew and the estimated input/output skew exceeds the respective central processing unit skew threshold and the input/output skew threshold.

22. The system of claim 19, wherein the processing module estimates processing characteristics by determining an estimated central processing unit duration per input/output operation for the respective one or more request steps, determines an estimate of processing time for the respective one or more request steps, wherein the processing module further compares the estimated central processing unit duration per input/output operation with a central processing unit duration per input/output operation threshold and assigns the problematic classification as a problematic central processing unit duration per input/output operation classification responsive to determining the estimated central processing unit duration per input/output operation exceeds the central processing unit duration per input/output operation threshold.

23. The system of claim 19, wherein the processing module estimates processing characteristics by determining an estimated memory usage for the respective one or more request steps, and wherein the processing module further compares the estimated memory usage with a memory usage threshold and assigns the problematic classification as a problematic memory usage classification responsive to determining the estimated memory usage exceeds the memory usage threshold.
